(19) United States
(12) Patent Application Publication
(10) Pub. No.: US 2004/0165891 A1
(43) Pub. Date: Aug. 26, 2004

(54) Low-loss, efficient hub ring networks and methods for their use

(75) Inventors: Ben-Zion Kopelovitz, Kefar-Sava (IL); Gil Levi, Beit Hanan (IL); Reuven Duer, Westlake Village, CA (US)

Correspondence Address: DR. MARK FRIEDMAN LTD., C/o Bill Polkinghorn, Discovery Dispatch, 9003 Florin Way, Upper Marlboro, MD, 20772, US

(73) Assignee: LYNX PHOTONIC NETOWORKS INC.

(21) Appl. No.: 10/369,668

(22) Filed: Feb. 21, 2003

(51) Int. Cl. H04J 14/02

(52) U.S. Cl. 398/83; 398/59

(57) ABSTRACT

Methods and systems for eliminating extinguish losses in a hub ring network that includes Optical Add Drop Multiplexers (OADMs). The need for a wavelength extinguishing function is eliminated by ensuring that when a wavelength is added to the optical path at a certain node in the ring, the arriving traffic in the path before the addition does not contain that wavelength. The methods include using different wavelengths for the drop and the add operations, ensuring that a trough traffic does not include local ADD wavelengths which are subsequently combined with the through wavelengths, and bi-directional transmission on one or two separate fibers of identical dropped and added wavelengths. Systems include the use of simple, inexpensive, half or fully dynamic OADMs implementing the low-loss functionality.

### FIELD AND BACKGROUND OF THE INVENTION

The present invention relates to optical communication systems, in particular wavelength division multiplexed (WDM) ring communication networks that incorporate a node acting as a “hub” (hereinafter “hub ring networks” or simply “hub networks”). Specifically, the present invention relates to hub networks that include optical elements known as Optical Add Drop Multiplexers (OADMs), which allow both addition and dropping of traffic carrying channels at nodes of the system (including the hub node). More specifically, the present method relates to hub networks incorporating OADMs that allow effective elimination of extinguish losses.

Various OADM architectures, including dynamic OADMs as well as networks using them are well known, as described for example in U.S. Pat. No. 6,243,175 to Pelekhati, U.S. Pat. No. 6,426,815 to Koehler, and U.S. Pat. No. 6,208,443 to Liu et al., which are incorporated herein by reference. In hub networks, the traffic is always between the hub node (or simply “hub”) and an OADM node. The traffic from the hub is dropped at an OADM node, and the traffic added at an OADM node is sent to the hub.

FIG. 1 shows schematically the architecture of a hub system 20, in which a hub 22 is connected by two optical rings, fibers or “paths” 24 and 26 to a number of OADM nodes 28 (a-h). We will refer to these as simply nodes 28 (a-h). Hub 22 connects system 20 to a network, marked in the figure as “Metro Core”. Each node 28 includes a DROP section 30 and an ADD section 32, through which wavelengths can be respectively dropped or added to and from clients. As well known, the traffic in a hub system is directional. In FIG. 1 the traffic is either East (“E”) or counterclockwise on path 26, or West (“W”) or clockwise on path 24. The hub “opens” the ring, and transmits to and receives from both sides. In FIG. 1, each node receives signals from its West side on one ring, and transmits signals back to the West side on the second ring. For example, node 28d receives from hub 22 on the West part of ring 24 at an input 36, and transmits back to hub 22 on the West part of ring 26 at an output 38.

If a failure (e.g. line Cut) occurs in the system, as shown in FIG. 2 at a point 50, the traffic between hub 22 and all nodes on one side of the cut (original working side. in this case West of the hub to point 50) continues unaffected. In FIG. 2, the unaffected nodes are nodes 28 d, e, h. Nodes 28 a, b, c on the other hand are now cut from the hub on the West side, but the hub remains connected to them on the East side. Nodes 28 a, b, c now operate in their protection mode, in which the East side receives and transmits signals from and to the hub.

Each channel in a WDM system is typically transmitted at a unique wavelength. Nodes typically include filtering elements such as dielectric filters that facilitate the adding and/or dropping of the individual channels (wavelengths) while allowing the remaining channels to continue along an express or through path in the ring. A channel cannot carry two identical wavelengths in the same direction, so if a wavelength is added at an ADD section of an OADM node, the same wavelength has to be first removed or “extinguished” (that is significantly attenuated, for example by 40 dB) from the traffic reaching that ADD section. Wavelength extinguishing can occur in both the ADD (i.e. “Add and Extinguish”) and the DROP (i.e. “Drop and Extinguish”) sections of an OADM, and is in general quite disadvantageous for system performance, because it normally causes a loss in the express (or “through”) route that requires costly remedial solutions such as added amplifiers.

An OADM may be either fixed (i.e. a filtering element has to be physically changed if a different wavelength needs to be added or dropped) or dynamic. In fixed OADMs, the functionality of changing the extinguished wavelength in coordination with changes in the ADD section does not require a physical change of a filter. FIGS. 3 and 4 show two examples (of many existing ones) of prior art architectures of a typical fixed OADM architecture. The examples are shown using high-level block diagrams of an OADM (ADD/DROP protection is assumed in the electrical domain) for a hub ring. In FIG. 3, an OADM 60 includes two sections related to the East and West traffic ADD/DROP functions: a W-section 62 and an E-section 64. Each of the two sections includes wavelength extinguish capabilities: W-section 62 includes a “Drop and Extinguish” module 66, and an “Add and Extinguish” module 68, while E-section 64 includes an “Add and Extinguish” module 70 and a “Drop and Extinguish” module 72. Dropped wavelengths in each module are marked D1-D4 (only 4 wavelengths are shown for simplicity) and added wavelengths are marked A1-A4, with “W” and “E” defining the direction of the traffic. In FIG. 3, module 66 includes for filtering elements 70a-d, each of which can drop respectively one of four wavelengths λᵢ, λⱼ, λₖ, and λₘ. Similarly, module 68 includes four filtering elements 72a-d, each of which can add respectively one of four wavelengths λᵢ, λⱼ, λₖ, instead of an identical wavelength dropped in section 66. Section 62 thus allows the dropping of a channel with a specific wavelength arriving from the hub and entering the OADM from the West at a first port “In W”, and the addition of the same wavelength to a channel leaving the OADM back to the hub on the West part of the ring at a second port “Out W”. Similar functions are enabled by section 64 relative to East traffic between the OADM and the hub, in case the protection mode is operative. In the OADM of FIG. 3, the “Extinguish” function is performed mainly in the “Drop and Extinguish” modules of each section. However, additional or optional extinguishing can be performed in the “Add and Extinguish” modules.

One major disadvantage of the fixed OADM of FIG. 3 is that any change of a filter, either for maintenance or for a wavelength change, whether in the DROP or in the ADD sections, requires the interruption of the total traffic in that direction (equivalent to a fiber cut). Moreover, an express route contains the Drop loss in addition to the Extinguish loss when the Add and the Drop do not coincide. That is, if one drops λ₁ and adds λ₂, then one needs (at the ‘DROP) two filters, one for the ‘Drop’ (λ₁ filter) and another for the ‘Extinguish’ (λ₂ filter) functions. In the case when the Add and Drop relate to the same wavelength, a single filter can perform both ‘Drop’ & ‘Extinguish’ functions.

Various prior art methods and systems have dealt with the losses mentioned above and ways to reduce them. For example, U.S. Pat. No. 6,426,815 describes a dual hub system that has reduced through or express losses, the reduction achieved through the use of different wavelengths for the hub-to-node direction than for the node-to-hub direction. This use of different wavelengths removes the need for wavelength extinguishing. The reason for the dual-hub ring architecture in U.S. Pat. No. 6,426,815 is enhanced protection, i.e. one hub protects the other hub so the system is protected against a hub failure. However, the system still suffers from inefficient wavelength utilization (i.e. only half of the wavelengths can be used in each direction.

FIG. 4 show a prior art OADM node 80 in which all IN W signal 82 entering a DROP module 84 from the West is split by a splitter 86 into a DROP signal 88 and a Through or Continue Signal 90. The example is discussed in detail for a W-section 92, with the understanding that a similar situation exists for E-section 94. Splitter 86 may be a simple splitter, or a switch with multicasting capability to achieve optimized performance (e.g. if the East link is down, the IN W signal can be directed to DROP W only). in this architecture, the extinguishing is done exclusively in the “Add and Extinguish” circuits. The advantage over the OADM of FIG. 3 is that in the architecture of FIG. 4 one need not interrupt the express/ADD traffic while replacing a DROP wavelength, since the DROP function is isolated. This architecture also supports “Drop and Continue” functionality. In comparison with the system of FIG. 3, the losses at the DROP are now lower, however, the “Add and Extinguish” losses remain as a major disadvantage.

Using dynamic instead of fixed OADMs may significantly improve the performance of a hub network. One way to achieve a dynamic OADM is to add programmable connectivity features, as well known in the art. In hub applications (such as a Metro Access Ring), it is widely accepted that there is no use of tunable transmitters. Replacing a transmit wavelength at a ring node requires “truck rollaway”. However, the receiver is broadband and can receive at any wavelength, so the ADD part can stay fixed, while the DROP part can be changed to dynamic.

An exemplary “dynamic DROP” OADM architecture of this type is shown in FIG. 5. The main differences vs. FIG. 4 are in the two dynamic DROP modules 102 and 104 that replace fixed DROP modules, and in the addition of a Variable Optical Attenuator (VOA) to each filtering element of an ADD module. These are shown as VOA arrays 106 in the Add and Extinguish W module, and arrays 108 in the Add and Extinguish E module. The VOA arrays enable programmability of the ADD power, which is advantageous in that it removes the need for long manual calibrations after each change in the ring. In OADM 100, the wavelength extinguishing circuit is identical with that of the previous fixed OADMs, and the assumption is that the ADD wavelengths are identical (one to one) with the DROP wavelengths. The advantages of this dynamic OADM solution include simplification of network planning (since wavelengths are not “locked” to specific nodes), the possibility of adding/removing wavelengths at a node, depending on bandwidth requirements, and an easier overcoming of laser and/or receiver failures. However, keeping a fixed ADD part (module) results in the same disadvantage seen in a fixed OADM, i.e. a need to “open” the ring if Add/Extinguish filters need to be changed. In addition, the removal of the Drop and Extinguish function may lead to the loss of some extinguishing capability.

There is therefore a widely recognized need for, and it would be highly advantageous to have a hub ring network system in which the function of wavelength extinguishing is removed, thus allowing the use of relatively simple, small and inexpensive fully dynamic (in both ADD and DROP) OADMs.

### SUMMARY OF THE INVENTION

According to the present invention there is provided a method for eliminating extinguish losses in a N-wavelength carrying hub ring network having a plurality of ADD and DROP nodes, each ADD and DROP node communicating directly with the hub, the method comprising the steps of using a first plurality of N/2 wavelengths for all ADD operations, and using a second plurality of N/2 wavelengths different from the wavelengths of the first plurality for all DROP operations.

According to the present invention there is provided a method for eliminating extinguish losses in a N-wavelength carrying hub ring network comprising the steps of providing a plurality of optical add-drop multiplexers (OADMs), each OADM having at least one ADD and at least one DROP section, each ADD and DROP section communicating directly with the hub, using a plurality of N wavelengths for both ADD and DROP operations in the OADMs, and signaling the hub whether the ring operates in a normal or a protection mode, whereby the signaling enables, at an ADD section, the addition of a wavelength that has not been previously extinguished, thereby eliminating extinguish losses.

According to the present invention there is provided a method for eliminating extinguish losses in a hub ring network that includes a first pair of fibers, comprising the steps of providing a plurality of optical add-drop multiplexers (OADMs), each OADM having at least one ADD and at least one DROP section, each ADD and DROP section communicating directly with the hub through the fibers, adding at an ADD section and dropping at a DROP section a signal with the same wavelength, and transmitting the added and dropped signals having the same wavelengths in opposite directions on the same fiber of the first pair.

According to the present invention, the method for eliminating extinguish losses in a hub ring network that includes a first pair of fibers further comprises providing to the network a second pair of fibers connecting the hub with each of the OADMs, wherein the transmitting includes transmitting the added and dropped signals having the same wavelengths in opposite directions on separate fibers of each the pail.

According to a feature of each of the methods described above, all OADMs are preferably fully dynamic.

According to the present invention there is provided a low-loss two-ring hub network system comprising a plurality of half-dynamic OADMs including each, for each ring, a dynamic DROP section for dropping a plurality of wavelengths from the ring, and a fixed ADD section for adding the same plurality of identical wavelengths to the ring, means to provide through traffic that includes wavelengths other than the plurality dropped in the DROP section, and means to combine the through traffic wavelengths and the plurality of added wavelengths, whereby the need of extinguishing wavelengths in the system is removed.

According to the present invention there is provided low-loss two-ring hub network system comprising a plurality of dynamic OADMs including each, for each ring, a dynamic DROP section for dropping a plurality of wavelengths from the ring, and a dynamic ADD section for adding the same plurality of identical wavelengths to the ring, means to provide through traffic that includes wavelengths other than the plurality dropped in the DROP section, and means to combine the through traffic wavelengths and the plurality of added wavelengths, whereby the need of extinguishing wavelengths in the system is removed.

According to the present invention there is provided low-loss hub ring network system comprising a plurality of dynamic OADMs, each OADM having an ADD section and a DROP section, and means for bi-directional transmission of a wavelength dropped at one of the DROP sections and an identical wavelength added at one of the ADD sections, whereby the bi-directional transmission occurs on at least one ring of the ring network

### BRIEF DESCRIPTION OF THE DRAWINGS

The invention is herein described, by way of example only, with reference to the accompanying drawings, wherein:

FIG. 1 shows schematically the architecture of a prior art hub system under normal operating conditions;

FIG. 2 shows schematically the architecture of a prior art hub system under protection operating conditions;

FIG. 3 shows one architecture of a prior art fixed OADM;

FIG. 4 shows another architecture of a prior art fixed OADM;

FIG. 5 shows a prior art “dynamic Drop/fixed Add” OADM architecture;

FIG. 6 shows an embodiment of a half-dynamic OADM implemented in a hub system without wavelength extinguishing according to the present invention;

FIG. 7 shows an embodiment of a fully dynamic OADM implemented in a hub system without wavelength extinguishing according to the present invention;

FIG. 8 shows an embodiment of a two-ring hub system without wavelength extinguishing using bi-directional transmission of signals with the same wavelength;

FIG. 9 shows an embodiment of a four-ring hub system without wavelength extinguishing using bi-directional transmission of signals with the same wavelength;

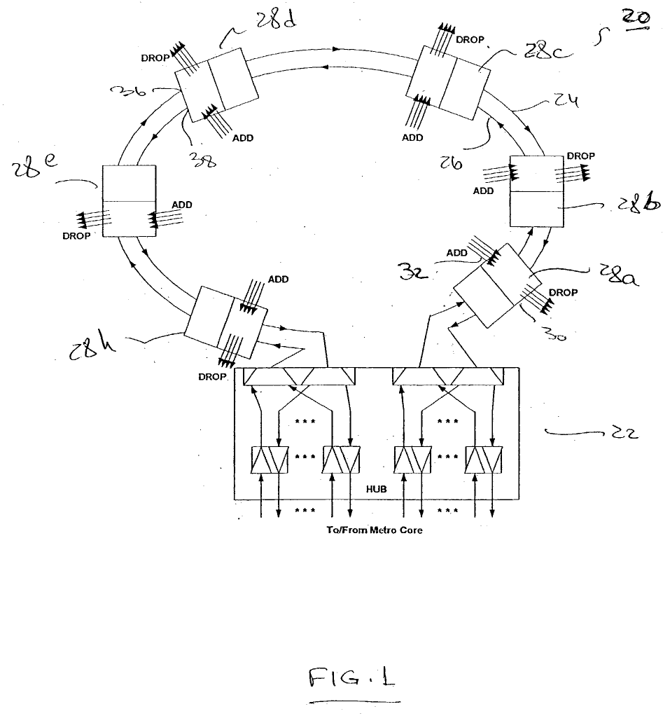

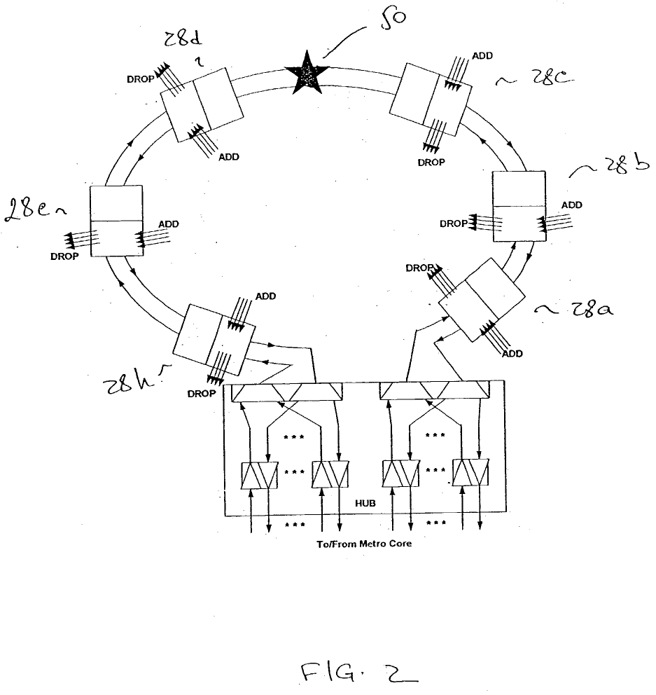

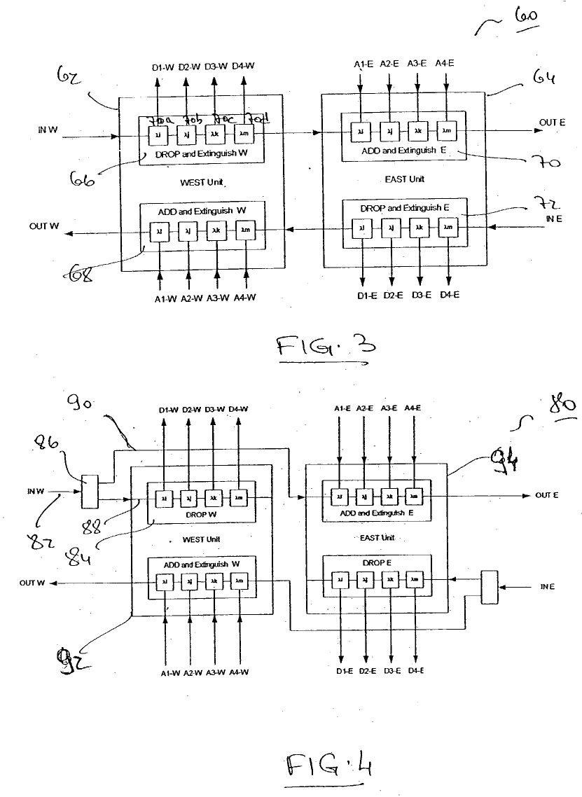

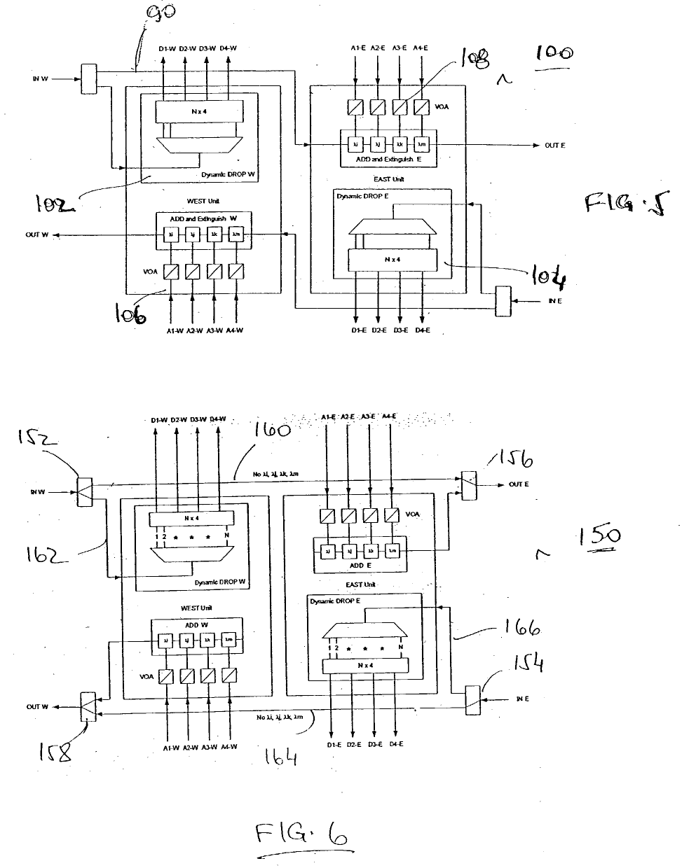

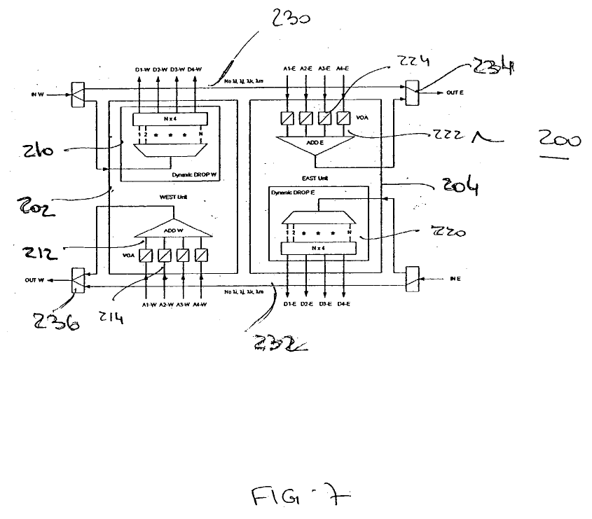

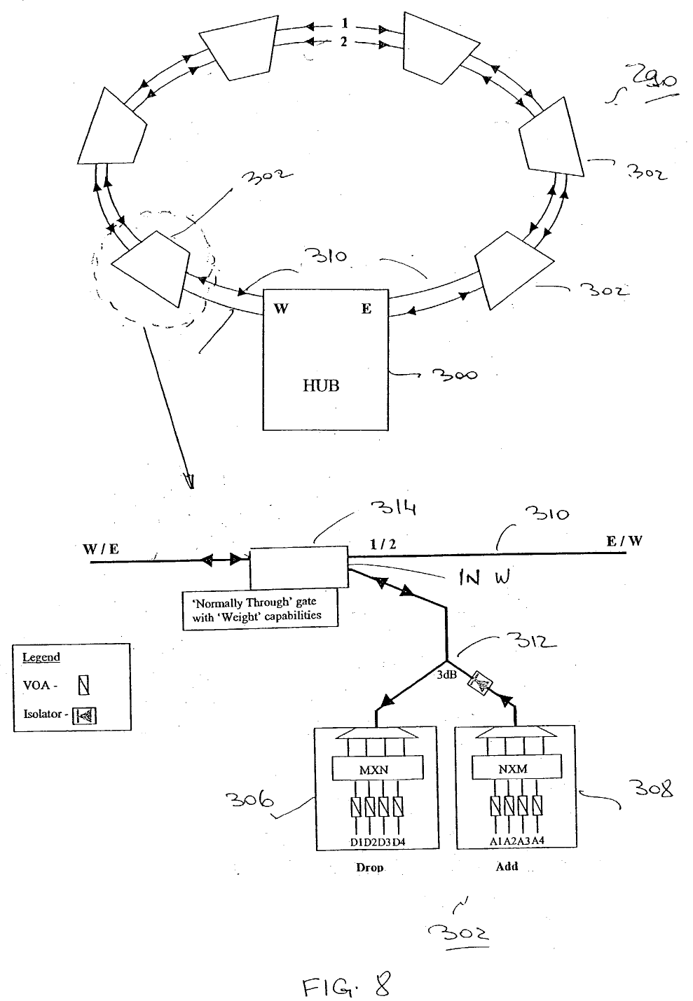

### DESCRIPTION OF THE PREFERRED EMBODIMENTS

The present invention describes methods and systems for reducing losses in a hub network. More specifically, the various embodiments of the methods and systems disclosed herein substantially eliminate wavelength-extinguishing losses in a hub network. These losses are eliminated by ensuring that when a wavelength is added to the optical path at a certain node in the ring, the arriving traffic in the path before the addition does not contain that wavelength. If the extinguish “problem” is solved as suggested in the present invention, a hub network system can be implemented with simpler, relatively smaller and cheaper Fully dynamic OADMs, thus providing a fully dynamic hub network. Such OADMs can be employed in any system that does not require the “Extinguish” function, specifically in hub rings and in any ring system in which no two ADDs use the same wavelength.

A hub ring in which the express wavelengths never contain the local ADD wavelengths, and which can then include fully dynamic OADMs as described below can be realized and used in a number of ways:

1. In a first embodiment, in an exemplary 40-wavelength ring, one can use only 20 wavelengths for all ADD operations, and 20 other wavelengths for all DROP operations. Alternatively, if all 40 wavelengths are required for both ADD and DROP operations, a 80-wavelength (50 GHZ spacing) ring can be used, where all odd wavelengths are used for all ADD operations, and all even wavelengths are used for all DROP operations (or vice versa). The 40 or 80-wavelength rings are used as examples only, with the understanding that the method works equally well with any N-wavelength ring, where N is an even number preferably between 24 and 96.

2. In a second embodiment, if all N wavelengths are required for both ADD and DROP operations but a 50 GHz spacing is to be avoided, then there is a need to block some signals from the hub according to some protection logic, i.e. to activate a protection “scenario”. While the ring is working fine, the hub transmission is passed in only one direction (“normal” connection) and is blocked in the other. Simple signaling within the OADM ring can automatically identify whether the ring operates in a “normal” or a “protection” mode. Such signaling can be achieved for example by the transmission of a dedicated test signal across the ring, or by making sure there is at least one DROP at any of the two end OADM nodes that are immediate neighbors on each side of the hub. In the latest case if the DROP is lost in such a node then there is a cut in the ring, and the end node sensing it should block the signal from the hub.

3. In a third embodiment, wavelength extinguishing and its associated losses can be avoided by bi-directional transmission of optical signals with the same wavelength in the fiber, as explained in more detail below.

The principles and operation of fully dynamic hub ring networks without extinguishing losses according to the present invention may be better understood with reference to the drawings and the accompanying description. Each implementation of dynamic OADMs in a hub ring network described below assumes a hub ring in which the express wavelengths never contain the local ADD wavelengths.

Referring now to the drawings, FIG. 6 shows an embodiment in which a hub system without wavelength extinguishing according to the present invention is implemented using half-dynamic OADMs. The figure shows a half-dynamic OADM 150 having a fixed ADD (separated from the ring and thus not interfering with the ‘Through’ traffic) and a dynamic DROP architecture. In contrast with the system of U.S. Pat. 6,426,815, the hub system based on the OADM of FIG. 6 does not require wavelength extinguishing, and has therefore no Extinguish losses. In addition to all elements shown in FIG. 5, OADM 150 includes means (e.g. a splitter) 152 and 154 to respectively split incoming the traffic at input ports IN-W and IN-E into “through” signals (wavelengths) and dropped signals. OADM 150 also includes means to combine through and added wavelengths in the form of a 2×1 switch 156 at the ‘Out E’ port and a 2×1 switch 158 at the ‘Out W’ port.

In use, traffic with wavelengths λ₁, λ₂, . . . λₘ traveling West from the hub enters OADM 150 through In W, and is split by splitter 152 into a Through traffic 160 to an output port Out E, and a Drop traffic 162 (including for example channels with wavelengths λ₁, λ₂, λ₄, and λ₄) dropped to one of four DROP ports D1-W to D4-W through a dynamic DROP W. Similarly, traffic with wavelengths λ₁, λ₂, . . . λₘ traveling East from the hub enters OADM 150 through In E, and is split by splitter 154 into a Through traffic 164 to an output port Out E, and a Drop traffic 166 (including for example channels with wavelengths λ₁, λ₂, λ₄, and λ₄) dropped to one of four DROP ports D1-E to D4-E through a dynamic DROP E. Through traffic 160 is added at switch 156 to signals added at ADD E, and Through traffic 164 is added at switch 158 to signals added at ADD W. Through traffics 160 and 164 carry channels with wavelengths other than the dropped λ₁, λ₂, λ₄, and λ₄, so that any of these wavelengths can be added by the ADD modules without need for an extinguish operation in a previous section of the optical path. Therefore, advantageously, a hub system using OADMs such as OADM 150 has low losses because the extinguish losses are substantially eliminated.

FIG. 7 shows an embodiment in which a hub system without wavelength extinguishing, according to the present invention is implemented using fully dynamic OADMs. In this embodiment, an OADM 200 is fully dynamic in both ADD and DROP functions, and additionally, VOA arrays are added to the ADD modules. OADM 200 includes two basically identical sections, a W-section 202 and an E-section 204, each section further including dynamic ADD and DROP modules. Thus W-section 202 has a dynamic W-DROP module 210 and a W-ADD module 212 that includes a VOA array 214, while E-section 204 has a dynamic E-DROP module 220 and an E-ADD module 222 that includes a VOA array 224. The internal structure of DROP modules 210 and 220 and ADD modules 212 and 222 is well known in the art, and in fact can be implemented in a number of different ways. In use, two express (or through) paths 230 (from IN-W to OUT-E) and 232 (from IN-E to OUT-W) carry channels with wavelengths other than λᵢ, λⱼ, λₖ, and λₘ, so, that any of these wavelengths can be added by the ADD modules without need for an extinguish operation in a previous section of the optical path. As in FIG. 6, the express signals are combined with the added signals at the ADD modules in 2×1 switches 234 (for West to East traffic) and 236 (for East to West). Since the extinguish function is not needed in this system, advantageously, the fully dynamic OADMs employed may be made simple and relatively inexpensive.

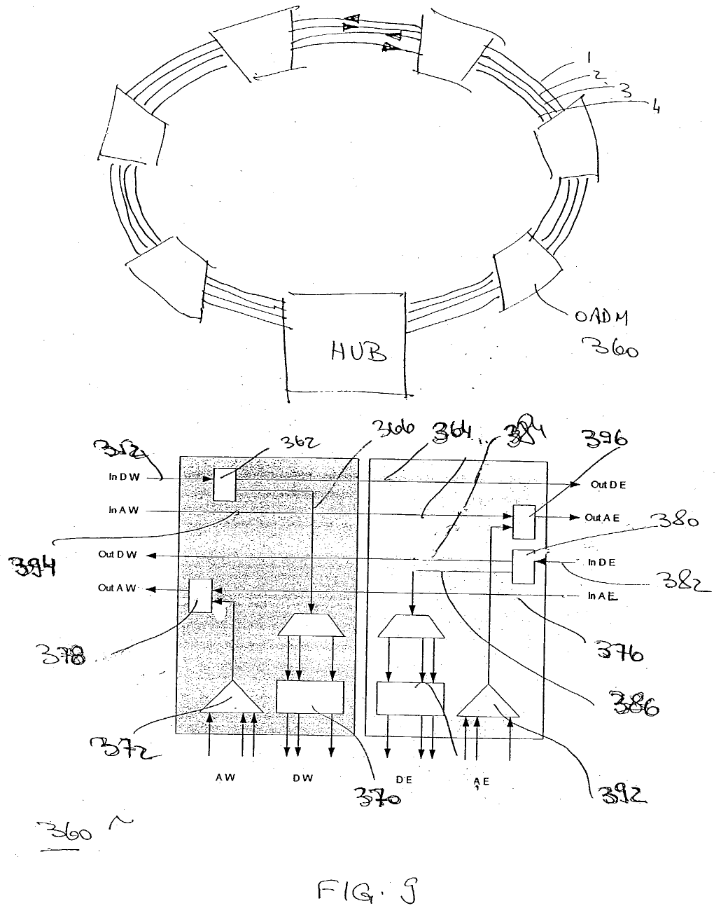

In yet another embodiment of the low-loss hub system of the present invention, shown in FIG. 8, wavelength extinguishing and its associated losses are avoided by using bi-directional transmission of optical signals with the same wavelength in the same fiber. A two-ring hub network 290 includes a plurality of OADMs 302, preferably fully dynamic. Each OADM 302 includes a DROP section 306 and an ADD section 308. Both sections are coupled to a fiber 310 through coupling means that include a coupler (e.g. a 3 dB coupler) 312, and a normally “through” gate with weighting capabilities 314. In use, in the normal mode of operation, a channel with wavelength λᵢ traveling West on fiber 310 enters OADM 302 through a port IN W and is dropped in DROP section 306. A channel with the same wavelength λᵢ is then added in ADD section 308 of OADM, 302, and coupled through coupler 312 to travel into an opposite travel direction on fiber 310. That is, added wavelength λᵢ travels East on fiber 310, exiting the OADM at the same IN W port. Since the signals travel in the opposite direction, there is no interaction between them. At the same time, there is no need for any Extinguish function, therefore Extinguish losses are eliminated.

In yet another embodiment of the low-loss hub system of the present invention, shown in FIG. 9, a hub network employing the OADM shown in FIG. 9 uses four fibers, two for the normal mode and two for the protection mode of operation. This contrasts with the system of FIG. 8, in which the bi-directional transmission is on the same fiber (and the hub ring network has two fibers, one for normal and the other for protection operation). In many cases, existing fiber networks have significant fiber overcapacity in the access, so the need for four instead of two fibers to carry the data is not problematic or disadvantageous. FIG. 9 shows in detail an OADM 360, for example a fully dynamic N- wavelength OADM that can be used to implement such a system without need of wavelength extinguishing. In the normal mode of operation, traffic with wavelengths λ₁, λ₂, . . . λₙ traveling West from the hub on a fiber 352 enters OADM 360 through a first input port In DW, and is split by a splitter 362 into a Continue part 364 to a first output port Out DE, and a Drop part 366 dropped through a demultiplexer 370 to a DROP port DW. Traffic with the same wavelengths is added at an ADD section AW through a multiplexer 372 and combined with traffic traveling from East (input In AE) to West on a second fiber 376 in a combiner 378. The combiner can be simply an array waveguide grating (AWG) combiner or a combined switch-matrix +AWG combiner. In the protection mode of operation, traffic with wavelengths λ₁, λ₂, . . . λₙ traveling East from the hub on a fiber 380 enters OADM 360 through a first input port In DE, and is split by a splitter 382 into a Continue part 384 to a first output port Out DW, and a Drop part 386 dropped through a demultiplexer 388 to a DROP port DE. Traffic with the same wavelengths is added at an ADD section AE through a multiplexer 392, and combined with traffic traveling from West (input In AW) to East on a second fiber 394 in a combiner 396. The use of two separate sets of fibers removes the need for bi-directional transmission on the same fiber, and removes the need for extinguishing. This use is particularly advantageous in existing networks with overcapacity of fibers, in which there is no need to actively provide an additional fiber pair, as they are already in the infrastructure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is

1. A method for eliminating extinguish losses in a N-wavelength carrying hub ring network having a plurality of OADMs with ADD and DROP sections, each ADD and DROP section communicating directly with the hub, the method comprising the steps of
a. using a first plurality of N/2 wavelengths for all ADD operations, and
b. using a second plurality of N/2 wavelengths different from said wavelengths of said first plurality for all DROP operations.

2. The method of claim 1, wherein said N is an even number between 24 and 96, each wavelength of said first plurality being an even wavelength, each wavelength of said second plurality being an odd wavelength, said even and odd wavelengths inter-dispersed with an equal spacing therebetween.

3. The method of claim 1, wherein said OADMs are fully dynamic.

4. A method for eliminating extinguish losses in a N-wavelength carrying hub ring network the method comprising the steps of:
a. providing a plurality of optical add-drop multiplexers (OADMs), each said OADM having at least one ADD and at least one DROP section, each said ADD and DROP section communicating directly with the hub;
b. using a plurality of N wavelengths for both ADD and DROP operations in said OADMs; and
c. signaling the hub whether the ring operates in a normal or a protection mode, whereby said signaling enables, at a said ADD section, addition of a wavelength that has not been previously extinguished, thereby eliminating extinguish losses.

5. The method of claim 4, wherein said signaling includes signaling of a test signal across the ring.

6. The method of claim 4, wherein said signaling includes sensing a lost DROP signal at a said OADM nearest to the hub.

7. The method of claim 4, wherein said OADMs are fully dynamic.

8. A method for eliminating extinguish losses in a hub ring network that includes a first pair of fibers, comprising the steps of:
a. providing a plurality of optical add-drop multiplexers (OADMs), each said OADM having at least one ADD and at least one DROP section, each said ADD and DROP section communicating directly with the hub through the fibers;
b. adding at a said ADD section and dropping at a said DROP section a signal with the same wavelength; and
c. transmitting said added and dropped signals having the same wavelengths in opposite directions on the same fiber of the first pair.

9. The method of claim 8, further comprising providing to the network a second pair of fibers connecting the hub with each of said OADMs, wherein said transmitting includes transmitting said added and dropped signals having the same wavelengths in opposite directions on separate fibers of each said pair.

10. The method of claim 8, wherein said OADMs are fully dynamic.

11. The method of claim 10, wherein said OADMs are fully dynamic.

12. A low-loss two-ring hub network system comprising:
a. a plurality of OADMs including each, for each ring, a dynamic DROP section for dropping a plurality of wavelengths from said ring, and a fixed ADD section for adding the same plurality of identical wavelengths to said ring,
b. means to provide through traffic that includes wavelengths other than said plurality dropped in said DROP section, and
c. means to combine said through traffic wavelengths and said plurality of added wavelengths, whereby the need of extinguishing wavelengths in the system is removed.

13. A low-loss two-ring hub network system comprising:
a. a plurality of dynamic OADMs including each, for each ring, a dynamic DROP section for dropping a plurality of wavelengths from said ring, and a dynamic ADD section for adding the same plurality of identical wavelengths to said
b. means to provide through traffic that includes wavelengths other than said plurality dropped in said DROP section, and
c. means to combine said through traffic wavelengths and said plurality of added wavelengths, whereby the need of extinguishing wavelengths in the system is removed.

14. A low-loss hub ring network system comprising:
a. a plurality of dynamic OADMs, each said OADM having an ADD section and a DROP section, and
b. means for bi-directional transmission of a wavelength dropped at one said DROP sections and an identical wavelength added at one of said ADD sections, whereby said bi-directional transmission occurs on at least one ring of the ring network.

15. The system of claim 13, wherein said ring network is a two-fiber network, and wherein said at least one ring includes one fiber.

16. The system of claim 13, wherein said ring network is a four-ring network that includes a pair of normal transmission fibers and a pair of protection transmission fibers, and wherein said bi-directional transmission occurs on separate fibers of each said pair of fibers.
